(19) United States
(12) Patent Application Publication
(10) Pub. No.: US 2008/0292801 A1
(43) Pub. Date: Nov. 27, 2008

(54) Corrosion-Preventive Adhesive Compositions

(75) Inventors: Jayesh P. Shah, Plaistow, NH (US); Bo Xia, Lexington, MA (US); Chih-Min Cheng, Westford, MA (US)

Correspondence Address: NATIONAL STARCH AND CHEMICAL COMPANY, P.O. BOX 6500, BRIDGEWATER, NJ, 08807-3300, US

(73) Assignee: National Starch and Chemical Investment Holding Corporation, New Castle, DE (US)

(21) Appl. No.: 11/752,591

(22) Filed: May 23, 2007

(51) Int. Cl. C08K 3/08; B05D 3/00; C08K 3/04

(52) U.S. Cl. 427/388.1; 524/408; 524/434; 524/440; 524/441; 524/612

(57) ABSTRACT

The present invention concerns adhesive compositions that provide corrosion-preventative properties and improved adhesive bonding on corrodible surfaces, such as may be found in electronic components. These compositions provide the substrates with greatly increased resistance to corrosion, especially during long term exposure to high temperatures and/or high humidity. When used on conductive substrates, the compositions also maintain good initial and ongoing electrical conductivity.

### BACKGROUND OF THE INVENTION

The present invention relates to compositions that provide corrosion-preventative properties and improved adhesion on corrodible surfaces, such as may be found in electronic components, and, in one embodiment, to compositions that provide improved initial conductivity and overall conductivity stability.

### SUMMARY OF THE INVENTION

The present invention is directed to a corrosion-preventive adhesive composition comprising a radical curing resin, a filler and an azo compound.

In one embodiment of the invention, the radical curing resin is present in an amount of from about 5 to about 95 weight percent of the composition; the filler is present in an amount of from about 2 to about 95 weight percent of the composition; and the azo material is present in an amount of from about 0.1 to about 10 weight percent of the composition, based on the total solids in the coating composition.

In another embodiment, the radical curing resin is present in an amount from about 10 to about 60 weight percent of the composition; the filler is present in an amount of from about 5 to about 85 weight percent of the composition; and the azo compound is present in an amount of from about 0.2 to about 5 weight percent of the composition. Unless otherwise specified, all weight percents given herein are based on the total weight of solids in the coating composition.

The composition of the present invention can also be directed to a method of coating metal substrates to prevent corrosion. This method comprises the steps of applying the corrosion-preventive adhesive composition to a metal substrate and drying it preferably at ambient temperature.

The coated substrate may be bonded to a second substrate under heat and cured to form an assembled part and exposed to harsh environments, such as environments having high humidity and high temperature, with minimal or no corrosion of the part.

### DETAILED DESCRIPTION OF THE INVENTION

In electronic devices, conductive elements may be bonded to one another by means of electrically-conductive adhesives. For example, wireless cards may be bonded to thick metal backers, especially those formed from aluminum and its alloys, using electrically-conductive adhesives. Circuit boards or cards can be directly bonded, adhesively and electrically, to metal substrates such as metal heatsinks by means of electrically-conductive adhesives. In some applications, a continuous electrically-conductive surface of the component can be bonded to the metal backing by a continuous layer of an electrically-conductive adhesive. In other applications, selective areas of the component, for example electrical contacts on a card or circuit board surface, can be bonded to the metal backer by means of individual, discrete, normally co-planar layers of electrically-conductive adhesive, each discrete layer being associated with one electrical contact on the board. Conductive adhesives may also be used to bond integrated circuit chips to substrates (die attach adhesives) or circuit assemblies to printed wire boards (surface mount conductive adhesives).

In high volume applications, such as with reel to reel continuous processes as used, for example, for radiofrequency identification (RFID), where low cost substrates like PET and paper are common, electrically-conductive adhesives with different properties are required. Typical antenna metallization for RFID applications may be printed Ag ink, etched aluminum or etched or VD Cu. RFID inlays consist of an antenna and an RFID silicon chip and these are assembled usually with an anisotropic conductive adhesive or a non conductive adhesive. Methods for making RFID inlays include the use of die strap. Die strap consists usually of die with extended metal leads on PET substrate. The die strap process may involve dispensing isotropic conductive adhesive onto pads in a set pattern on a running web and placing the die strap without stopping the web and then curing and securing the connection in, for example, an oven. The die strap can be processed continuously in a reel to reel assembly, and does not require pressure during bonding.

When using conductive adhesives on non-noble metal surfaces, the formation of metal oxide, hydroxide, and other corrosion products at the interface between the conductive adhesive and the metal surface can compromise the electrical and mechanical stability of the adhesive and, as a result, adversely affect the performance and reliability of the associated electronic device. This is more prevalent in humid environments, especially in the case of aluminum where exposure to high temperatures and humidity induces a transformation of the aluminum oxide to aluminum hydroxide (Al(OH)₃). As a result of this transformation, the thickness of the oxide layer changes and the mechanical integrity of the adhesive/aluminum oxide interface becomes weaker. Such transformations can also lead to substantial increases in interfacial electrical resistance through the bond and ultimately to mechanical separation of the bonded surfaces (adhesive to aluminum).

Applicants have discovered that the incorporation of an azo compound, radical curing resin and filler in the corrosion-preventive adhesive compositions of this invention results in a reduction in, or inhibition of, electrochemical corrosion and the prevention of increases in electrical resistivity. In addition, the corrosion-preventive adhesive compositions of this invention do not require the addition of known corrosion inhibitors.

In a non-limiting aspect, the corrosion-preventive adhesive compositions of this invention reduce or eliminate corrosion associated with metal/adhesive bonds.

In one embodiment, the corrosion-preventive adhesive compositions are one component systems that cure rapidly at temperatures less than about 130° C. to provide stable bonds on metal substrates.

In another embodiment, when the filler is a conductive filler, this invention provides corrosion-preventive adhesive compositions that form strong electrical connections on, and between, metal substrates. The corrosion-preventive adhesive compositions protect metal substrates from oxidation and maintain good electrical conductivity even when the bond is subjected to humid environments over extended periods of time.

In one embodiment the metal substrates are non-noble metal substrates.

In another embodiment, the metal substrates are aluminum.

In one embodiment, the corrosion-preventive adhesive composition of this invention comprises azo compounds that are polymerization initiators, also known as azo initiators

In another embodiment, the azo initiators are selected from 2,2′-azobis(2,4-dimethylvaleronitrile); 2,2′-azobis(4-methoxy-2,4-dimethylvaleronitrile); 2,2′-azobis(2-amidinopropane)dihydrochloride; 2,2′-azobis(isobutyronitrile); 2,2′-azobis-2-methylbutyronitrile; 1,1-azobis(1-cyclohexanecarbonitrile); 2,2′-azobis(2-cyclopropylpropionitrile); and 2,2′-azobis(methyl isobutyrate).

In yet another embodiment, the azo initiator is 2,2′-azobis(2,4-dimethylvaleronitrile) a proprietary material available from DuPont under the trade name VAZO® 52.

In a non-limiting aspect, the radical curing resin is selected from the group consisting of acrylate resins, methacrylate resins, maleimide resins, bismaleimide resins, vinylester resins, poly(butadiene) resins, and polyester resins.

In another non-limiting aspect, the radical curing resin is an acrylate resin.

In one embodiment of the invention, the radical curing resin is present in an amount of from about 5 to about 95 weight percent of the composition; the filler is present in an amount of from about 2 to about 95 weight percent of the composition; and the azo material is present in an amount of from about 0.1 to about 10 weight percent of the composition, based on the total solids in the coating composition.

In another embodiment, the radical curing resin is present in an amount from about 10 to about 60 weight percent of the composition; the filler is present in an amount of from about 5 to about 85 weight percent of the composition; and the azo compound is present in an amount of from about 0.2 to about 5 weight percent of the composition. Unless otherwise specified, all weight percents given herein are based on the total weight of solids in the coating composition.

In one embodiment, the filler is a conductive filler.

In another embodiment, the conductive filler is a transparent conductive filler.

In yet another embodiment, the transparent conductive filler is indium tin oxide solder.

In another embodiment, the conductive filler is selected from silver, copper, nickel, gold, tin, zinc, platinum, palladium, iron, tungsten, molybdenum, carbon black, carbon fiber, aluminum, bismuth, tin, bismuth-tin alloy, carbon nano tube, silver coated glass, graphite, conducting polymer, metal coated polymer and mixtures thereof.

In a non-limiting aspect, the corrosion-preventive adhesive composition of the present invention has a paste consistency and can be applied by dispensing, jetting, stencil printing, screen printing or by any known method of application. In the case of RFID, the corrosion-preventive adhesive composition may be applied to the antenna pads prior to placing the strap and curing with heat.

The composition of the present invention can also be directed to a method of coating metal substrates to prevent corrosion. This method comprises the steps of applying the corrosion-preventive adhesive composition to a metal substrate and drying. In one embodiment, drying occurs at room temperature. The coating may be applied to the substrate by doctor blade, brushing, spraying, stencil or screen printing and other conventional coating techniques. The coated substrate may be bonded to a second substrate under heat and cured to form an assembled part and exposed to harsh environments, such as environments having high humidity and high temperature, with minimal or no corrosion of the part.

In a non-limiting aspect, the corrosion-preventive adhesive composition of this invention may be used in any consumer product that is subject to corrosion.

In one embodiment, the corrosion-preventive adhesive composition of this invention may be used in photovoltaic and/or RFID devices.

Optionally, the corrosion-preventive adhesive composition may further comprise such conventional additives as surfactants, accelerators, inhibitors, diluents and active solvents, in amounts that do not deleteriously affect the properties of the composition. In the case of solvents, different solvents may be used depending on whether the corrosion-preventive adhesive composition is to be sprayed, brushed, etc., e.g. if a higher solids coating is desired for brush application it may be advantageous to use a low vapor pressure solvent such as a dimethyl ester mixture, e.g. a mixture of dimethyl succinate, dimethyl glutarate and dimethyl adipate to extend the pot life of the composition. The amount of solvent present in the composition will depend on the particular solvent used, and the desired viscosity of the coating. If a low volatile organic compound (voc) coating is desired, it is generally necessary to brush-apply the coating, so that a lower level of solvent may be used, e.g. the ratio of solids to solvent may be from about 50:50 to 40:60.

In order to more thoroughly illustrate the present invention, the following examples were conducted.

### EXAMPLES

The corrosion-preventive adhesive compositions described in Table 1 were prepared as follows:

For each example, a mixture of resins was added to a mixing vessel equipped with a propeller stirrer. The initiator as indicated in Table 1 was added and mixed until a uniform solution was obtained. The specified filler was then added and mixed for 20-30 minutes. The mixture was then de-gassed for 5 minutes in a vacuum chamber at a pressure of >71 cm Hg.

TABLE 1

| | Example 1 | Example 2 | Example 3 | Example 4 |
|---|---|---|---|---|
| Filler Type | Ag | Ag/Ni | Ag | Ag/Ni |
| Filler | 85 | 73/9 | 80 | 73/9 |
| Loading % | | | | |

| Chemistry | Acrylate | |
|---|---|---|
| Initiator | 2,2′-Azobis(2,4- | Luperox-10 |
| | dimethylvaleronitrile) | |

| | |
|---|---|
| Substrate | Vapor deposited Cu/etched Al |

“Luperox-10” is 75 wt % tert-butylperoxyneodecanoate in odorless mineral spirits, available form Elf Atochem N. A.

The electrical properties of the adhesive bonds formed by the corrosion-preventive adhesive compositions of Examples 1, 2, 3 and 4 were then tested by measuring their resistance across a substrate of vapor deposited Cu/etched Al (prepared as shorted strap (Vd—Cu)/antenna (etched Al) assemblies) using ohm meter. The assemblies were exposed in a humidity chamber maintained at 85° C. and 85% relative humidity and the resistance was measured initially and then after period of 14 days to determine the effect on the electrical properties of the bonds under high humidity conditions.

The electrical properties for the corrosion-preventive adhesive compositions from Examples 1, 2, 3 and 4 are provided in the Table 2. Results showed that, under the specified conditions of heat and humidity, the corrosion-preventive adhesive compositions with azo initiator had more stable contact resistance on Al, Cu surface than the corrosion-preventive adhesive compositions with peroxide initiator.

TABLE 2

| | Example 1 | | Example 2 | | Example 3 | | Example 4 | |
|---|---|---|---|---|---|---|---|---|
| | Contact Resistance (ohm) | | | | | | | |
| | Initial | 14 days | Initial | 14 days | Initial | 14 days | Initial | 14 days |
| Average | 0.143 | 0.353 | 0.145 | 0.22 | 0.365 | 2.88 | 0.34 | 0.68 |
| Standard Deviation | 0.05 | 0.11 | 0.045 | 0.05 | 0.107 | 3.79 | 0.108 | 0.39 |

The corrosion-preventive adhesive compositions examples, provided as Examples 5 and 6, in Table 3 were prepared in the same manner as the Examples provided in Table 1.

TABLE 3

| | Example 5 | Example 6 |
|---|---|---|
| Filler Type | Ag/Ni | Ag/Ni |
| Filler Loading % | 73/9 | 73/9 |

| | |
|---|---|
| Chemistry | Acrylate |
| Initiator | 2,2′-Azobis(2,4-dimethylvaleronitrile) |

| | | |
|---|---|---|
| Substrate | etched Al grade | etched Al grade |
| | 1/grade 1 | 1/grade 2 |
| Contact resistance @ | 0.024 ± 0.001 | 0.034 ± 0.002 |
| initial, (ohm) | | |
| Contact resistance @ | 0.026 ± 0.0007 | 0.039 ± 0.001 |
| 14 days, (ohm) | | |

The results show clearly that the corrosion-preventive adhesive compositions of the present invention provides very stable joint resistance up to 14 days in 85° C./85 RH damp heat condition on different grades of etched Al.

1. A corrosion-preventive adhesive composition comprising (a) a radical curing resin, (b) a filler, and (c) an azo compound.

2. The corrosion-preventive adhesive composition according to claim 1 in which the azo compound is an azo initiator.

3. The corrosion-preventive adhesive composition according to claim 2 in which the azo compound is selected from the group consisting of 2,2′-azobis(2,4-dimethylvaleronitrile); 2,2′-azobis(4-methoxy-2,4-dimethylvaleronitrile); 2,2′-azobis(2-amidinopropane)dihydrochloride; 2,2′-azobis(isobutyronitrile); 2,2′-azobis-2-methylbutyronitrile; 1,1-azobis(1-cyclohexanecarbonitrile); 2,2′-azobis(2-cyclopropylpropionitrile); and 2,2′-azobis(methyl isobutyrate).

4. The corrosion-preventive adhesive composition according to claim 3 in which the azo compound is 2,2′-azobis(2,4-dimethylvaleronitrile).

5. The corrosion-preventive adhesive composition of claim 1, wherein the filler is a conductive filler.

6. The corrosion-preventive adhesive composition of claim 5, wherein the conductive filler is a transparent conductive filler.

7. The corrosion-preventive adhesive composition of claim 6, wherein the transparent conductive filler is indium tin oxide solder.

8. The corrosion-preventive adhesive composition of claim 5, wherein the conductive filler is selected from the group consisting of silver, copper, nickel, gold, tin, zinc, platinum, palladium, iron, tungsten, molybdenum, carbon black, carbon fiber, aluminum, bismuth, tin, bismuth-tin alloy, carbon nano tube, silver coated glass, graphite, conducting polymer, metal coated polymer and mixtures thereof.

9. The corrosion-preventive adhesive composition of claim 1, further comprising a free-radical initiator.

10. The corrosion-preventive adhesive composition of claim 9, wherein the free-radical initiator is a peroxide initiator.

11. The corrosion-preventive adhesive composition according to claim 1 comprising from about 5 to about 95 weight percent radical curing resin; from about 2 to about 95 weight percent filler; and from about 0.1 to about 10 weight percent azo compound.

12. The corrosion-preventive adhesive composition according to claim 11 comprising from about 10 to about 60 weight percent radical curing resin; from about 5 to about 85 weight percent filler; and from about 0.2 to about 5 weight percent azo compound.

13. The corrosion-preventive adhesive composition according to claim 1 in which the radical curing resin is selected from the group consisting of acrylate resins, methacrylate resins, maleimide resins, bismaleimide resins, vinylester resins, poly(butadiene)resins, and polyester resins.

14. The corrosion-preventive adhesive composition according to claim 13 in which the radical curing resin is an acrylate resin.

15. A method of coating a metal substrate to prevent corrosion, wherein such method comprises the steps of a) providing a corrosion-preventive adhesive composition according to claim 1; and b) applying the corrosion-preventive adhesive composition to the metal substrate.

16. A method of coating a metal substrate according to claim 15, wherein such method comprise the additional step of curing the corrosion-preventive adhesive composition.

17. A consumer product comprising the corrosion-preventive adhesive composition of claim 1.
